(19) United States
(12) Patent Application Publication
(10) Pub. No.: US 2025/0148447 A1
(43) Pub. Date: May 8, 2025

(54) PROCESSING PLATFORM

(71) Applicant: NationsBenefits, LLC, Plantation, FL (US)

(72) Inventors: Glenn Marc PARKER, Ft. Lauderdale, FL (US); Michael Ethan PARKER, Miami, FL (US); Robert Paul HABLUTZEL, Pittsboro, NC (US); Grahame Andrew JASTREBSKI, San Jose, CA (US); Roque SOLIS, Allen, TX (US); Michael Andrew FRIEDEL, San Ramon, CA (US); Larry Christopher VAN DER VEEN, San Carlos, CA (US); Ming OUYANG, Sunnyvale, CA (US)

(21) Appl. No.: 18/817,018

(22) Filed: Aug. 27, 2024

Related U.S. Application Data
(63) Continuation-in-part of application No. 18/504,801, filed on Nov. 8, 2023.

(51) Int. Cl. G06Q 20/20

(52) U.S. Cl. CPC G06Q 20/204

(57) ABSTRACT

Methods, systems, and storage media for processing transaction data are disclosed. Exemplary implementations may: receive transaction data wherein the transaction data is associated with the product purchased; analyze the transaction data; determine product eligibility for payment based on the program rules associated with the product purchased; and generate a transaction message indicating that the product or service was purchased.

### CROSS-REFERENCE TO RELATED APPLICATIONS

The present application is a continuation-in-part and claims priority to and the benefits of U.S. patent application Ser. No. 18/504,801, filed on Nov. 8, 2023, the entire content of which is incorporated herein by reference.

### TECHNICAL FIELD

The present disclosure generally relates to processing platforms, and more particularly to processing transaction data.

### BACKGROUND

The use of electronic payment systems has become increasingly popular in recent years. These systems allow consumers to make purchases using electronic devices, such as smartphones or credit cards, instead of cash. However, there are still challenges associated with these systems, such as the need for managed and constrained transaction processing. For example, there is a need for performing intelligent decision-making regarding products or services that are to be purchased and whether they will be approved. Various methods have been developed to address these challenges, including the use of unique messaging formats and proprietary payment processing paths. These existing methods, however, have the effect of limiting consumer choices in payment networks.

### BRIEF SUMMARY

The subject disclosure provides for systems and methods for processing payments. A user is allowed to reconcile and audit data by linking item data with pricing data using transaction IDs and purse summary information. One aspect of the present disclosure relates to a method for processing transaction data. The method may include receiving transaction data wherein the transaction data is associated with the products or services purchased. The purchase may include a transaction identifier. The method may include analyzing the transaction data. Analyzing the transaction data may include aggregating transaction data from a plurality of transactions. The method may include determining product(s) or service(s) eligibility for payment based on the program rules associated with the product or service purchased. It is understood that in embodiments of the present disclosure, “product” may refer to a single product or a plurality of products and “service” may refer to a single service or a plurality of services. This eligibility may depend on previous or schedule future purchases. The method may include generating a transaction message indicating that the product or service was purchased, returned, or similar conditions regarding the product or service. The transaction message may include a transaction identifier. The method may include transmitting the transaction message to a merchant acquirer or other intermediary, defined as any network or component between the Merchant Acquirer and Issuer Processor through which information flows as part of the payment transaction. In some embodiments, a transaction message to a merchant acquirer or other intermediary may not be transmitted.

Another aspect of the present disclosure relates to a system configured for processing transaction data. The processor(s) may be configured to receive transaction data wherein the transaction data is associated with the products or services purchased. The transaction data may be generated based on a purchase with a payment instrument (e.g., purchase card, tokens, cash, QR code, or similar) or other means of identification. The purchase may be completed at a point of sale (or, for example, at ecommerce, SMS, etc.). The purchase may include a transaction identifier. The processor(s) may be configured to analyze the transaction data. Analyzing the transaction data may include aggregating transaction data from a plurality of transactions, identifying program rules associated with the products or services purchased associated with each of the plurality of transactions. The processor(s) may be configured to determine product or service eligibility for payment based on the program rules associated with the product or service purchased. The processor(s) may be configured to generate a transaction message indicating that the product or service was purchased. The transaction message may include a transaction identifier. The processor(s) may be configured to transmit the transaction message to a merchant acquirer. In some embodiments, a transaction message to a merchant acquirer may not be transmitted.

Yet another aspect of the present disclosure relates to a non-transient computer-readable storage medium having instructions embodied thereon, the instructions being executable by one or more processors to perform a method for processing transaction data. The method may include receiving transaction data wherein the transaction data is associated with the product or service purchased. The transaction data may be generated based on a purchase with a payment instrument (e.g., purchase card, tokens, cash, QR code, or other payment instruments). The purchase may be completed at a point of sale. The purchase may include a transaction identifier. The method may include auditing of the transaction data associated with the transaction identifier. Auditing the transaction data may include matching the product or service with pricing data associated with the product or service. In this method, auditing may include evaluating the transaction data to determine the price for each product or service. The method may also include analyzing the transaction data. Analyzing the transaction data may include aggregating transaction data from a plurality of transactions, identifying program rules associated with the product or service purchased associated with each of the plurality of transactions. The method may include determining product or service eligibility for payment based on the program rules associated with the product or service purchased. The method may include generating a transaction message indicating that the product or service was purchased. The transaction message may include a transaction identifier. The method may include transmitting the transaction message to a merchant acquirer.

Still another aspect of the present disclosure relates how the system transmits transaction data. The system may include means for receiving additional transaction data, separate from purchase data, wherein the transaction data is associated with the product or service purchased. This data may be transmitted on a separate communications channel than the purchase transaction data. The system has the ability to associate additional transaction data to purchase data for the purpose of associating the analysis of such data to the purchase.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an overview of an environment in which some implementations of the disclosed technology can operate.

FIG. 2 illustrates an example flow diagram for processing transaction data with proprietary elements, in accordance with one or more implementations.

FIG. 3 illustrates an example flow diagram for processing transaction data with independent elements, in accordance with one or more implementations.

FIG. 4 illustrates a system configured for processing platforms, in accordance with one or more implementations.

FIG. 5 illustrates an example flow diagram for processing platforms according to certain aspects of the disclosure.

FIG. 6 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

In existing payment processing systems, decision-making about specific items (products or services) to be purchased is not possible unless a proprietary network is utilized to carry the customized formatted message from the Point of Sale terminal through to the transactional approver, typically through a Merchant Acquirer to an Issuer Processor. The Merchant Acquirer is a financial institution that processes a credit and/or debit card for a merchant, wherein the Issuer Processor can process a transaction with knowledge of cardholder credit limits and/or balances. While the intent with payment processing standards is that these two be independent of each other, existing solutions for managed and constrained transactions require the two (and all intermediaries between the two) be at least aware of each other, and generally be provided by the same entity, to carry specialized messages from the Merchant Acquirer and all intermediaries to the Issuer Processor. This is referred to as a “closed loop” network as component which implement only the standard payment processing standards cannot fully participate in the managed and constrained transaction.

A closed loop network requires one or more of the following elements: (1) a Merchant Acquirer, (2) a network to communicate between components (known as the “payment rails”), and (3) an Issuer Processor. Each of the participating elements must support specific message constructs that are unique to the provider of the closed loop network. For instance, the Merchant Acquirer may implement a data structure that is dictated by the Issuer Processor and enforce such a data structure be provided by the point-of sale (“POS”) system. The provided data structure(s) ensures the full set of data needed for a managed and constrained transaction is provided for each transaction(s). The Issuer Processor must receive the specialized data and use it to support the item level decision-making. The specialized data required is proprietary to the proprietor of the closed loop network.

This proprietary restriction is a technical problem because executing a such a proprietary payment for goods and/or services rendered results in several market inefficiencies, including inhibiting customer and merchant optionality on how to route transactions. For example, in the area of healthcare spend programs, the Issuer Processor providers are able to restrict payment processing pathways by requiring a specific Merchant Acquirer and payment rail for each program. Similar restrictions occur in other types of spend programs that implement managed and constrained rules to determine authorization for a potential purchase. As a result of this, to facilitate item level payment processing a retailer must support multiple interfaces to participate in each specific managed and constrained program.

This restriction is due to limitations of traditional payment networks, known as “open loop” networks. Traditional open-loop standards do not require shopping cart line-item details in their data structure, which prevents shopping cart data from being sent from a retailer to an Issuer Processor. The closed loop standards, which are incompatible with open loop standards, are therefore used to accommodate item level payloads. In existing implementations, these closed loop networks are proprietary extensions of the open loop networks, which use data elements in specific ways that are not guaranteed to be supported in the general open loop network case. Attempting to intermingle open and closed loop implementations results in data loss that prevents the realization of the managed and constrained programs.

The result of this is that, prior to the disclosure, each managed and constrained program is forced to utilize a proprietary or “closed loop” payment network all the way from the Merchant Acquirer to the Issuer Processor. As the closed loop Merchant Acquirer is often not preferred by the merchant, this creates the need for a duplicative integration with a specialized Merchant Acquirer, and logic in the point-of-sale system that forces all program transactions to that Merchant Acquirer. This increases costs to the merchant, negatively impacts choice, and generally means that managed and constrained programs do not meet the Dodd-Frank Act requirements.

To address the technical problem, the disclosure implements a SaaS (e.g., external or cloud-based) Basket Analysis Service (“BAS”) Module in conjunction with non-proprietary payment networks and components, including the Merchant Acquirer, the Issuer Processor, and the open loop network. The result of this is greater optionality for routing payment instructions while still maintaining the ability to provide detailed line-item, category level, or sub-category level decisions in alignment with program rules. The decoupling of the item level decisioning provides numerous advantages to the merchant, including ease of implementation, cost optimizations, and greater ability to adhere to regulations such as the so-called Durbin Amendment.

The BAS Module eliminates the reliance on proprietary payment networks and related Issuer Processors by providing managed and constrained spend adjudication rules separate from payment network. The BAS Module operates as a cloud-based SaaS, providing the functions of item level spend adjudication disassociated from the payment network. The effect of this disassociation allows retailers to integrate with any open-loop payment network composed of any Merchant Acquirer, payment system, or Issuer Processor.

In certain aspects, a cart information formatted message may be structured via the discretionary element 112 (DE112) or 124 (DE 124) field. This aspect allows the superposition of the hybrid channel and the ISO 8583 channel without necessitating a closed-loop environment. In one such aspect, the discretionary element can be formatted in four sections: a unique string of characters indicating the content is for system provider consumption, a body of purse authorization amounts, a single field that contains the transaction total value, and a unique string of characters indicating the end of the field content. This description is exemplary and not limiting.

The BAS Module can build transaction IDs and link item data with pricing data during the purchase of goods and services at a POS terminal. Separately from and following the actions of the BAS Module, the financial operations realizing money movement can be accomplished by using any generic (non-proprietary) merchant acquirer or Issuer Processor. A benefit of the implementation the BAS Module is that the payment process does not need formatting or creating any unique proprietary message. This eliminates redundancy within the merchant environment and allows the merchant to route payment messages to the Merchant Acquirer and on the network of their choice.

Some BAS implementations may also include a system of record for item level approvals, which allows for efficient reconciliation and data audit. This item level approval is separate from the financial transaction approvals, but can be combined by the BAS Module into a single consistent view. This removes the requirement of extending the existing Issuer Processor systems from recording the item level information, simplifying their implementation and eliminating the need to implement specialized data systems for the managed and constrained programs.

While many of the examples in this document focus on programs associated with healthcare programs, the disclosure can be extended beyond healthcare programs to other programs which require an adjudication based on spend program rules at the point-of-sale (“POS”). The healthcare examples are included for clarity and are not intended to constrain the applicability of this disclosure to other industries or use cases.

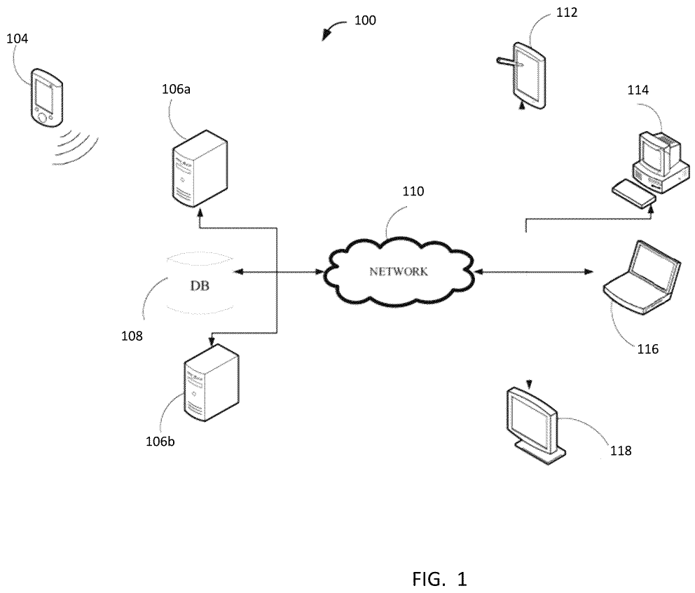

FIG. 1 is a block diagram illustrating an overview of an environment 100 in which some implementations of the disclosed technology can operate. The environment 100 can include one or more client devices, such as mobile devices 104, tablets 112, personal computers 114, laptops 116, desktops 118, and/or the like. Client devices may communicate via the network 110. The client devices can operate in a networked environment using logical connections through network 110 to one or more remote computers, such as server computing devices. The server computing devices 106a-106b may be configured to provide a basket adjudication services and other related services to one or more of the client devices. The client devices and computing devices can function as a POS. At the POS, a user can engage with the POS using a payment instrument (e.g., a credit/debit card, digital wallet, purchase card, tokens, cash, QR code, or other form of digital payment instrument). In general, adjudicating includes judging whether an item is eligible for payment based upon specific business or program rules, then determining how much should be paid based upon rules (e.g., digital discounts). Basket adjudication services may include examining each shopping cart line item, category level, or sub-category level to determine an item's eligibility, availability of funds, discount eligibility, and redemption. An item's eligibility may include determining that a purchased product or service is eligible for payment under a specific set of rules (e.g., defined by a healthcare provider). Availability of funds refers to determining what dollars (or other currency) are available to be spent on eligible items. Discount eligibility and redemption relate to determining that a specific line item, category level, or sub-category level has a digital discount that can be applied, and then subsequently using the digital discount on the item before consuming other funds to pay for the item.

In some implementations, the environment 100 may include an edge server which receives client requests and coordinates fulfillment of those requests through other servers. The server may include the server computing devices 106a-106b, which may logically form a single server. Alternatively, the server computing devices 106a-106b may each be a distributed computing environment encompassing multiple computing devices located at the same or at geographically disparate physical locations. Alternatively, the server computing may be in a public cloud. The client devices and server computing devices 106a-106b can each act as a server or client to other server/client device(s). The server computing devices 106a-106b can connect to a database 108 or can comprise their own memory. Each server computing device 106a-106b can correspond to a group of servers, and each of these servers can share a database 108 or can have their own database 108. The database 108 may logically form a single unit or may be part of a distributed computing environment encompassing multiple computing devices that are located within their corresponding server, located at the same, or located at geographically disparate physical locations or in a public cloud. The database 108 can store data indicative of adjudication and payment transactions that were attempted by a given Client/POS user using the BAS. The server computing devices may include general purpose computers (e.g., running a Linux operating system or Windows, or variant), mainframe, or special purpose machines. The databases may include relational databases (e.g., Postgres, SQL servers, etc.) or document stores (e.g., Mongo or Cosmos), or other mechanism for storing information. The server computing devices may be contained within a custom data center or be hosted in a managed cloud solution.

The network 110 can be a local area network (LAN), a wide area network (WAN), a mesh network, a hybrid network, or other wired or wireless networks. The network 110 may be the Internet or some other public or proprietary network. Client devices can be connected to network 110 through a network interface, such as by wired or wireless communication. The connections can be any kind of local, wide area, wired, or wireless network, including the network 110 or a separate public or proprietary network. In some implementations, the server computing devices 106a-106b can be used as part of a payment enabling system such as implemented via the network 110. The payment platform can facilitate payments by users through secure and encrypted transactions. Some transaction messaging can be formatted using an ISO 8583 standard or an arrangement of discrete elements. The ISO 8583 standard is intended to support using a payment instrument (e.g., a card, tokens, cash, QR code, or other payment instrument) to purchase goods. The ISO 8583 standard also defines a set of data elements, such as card number, CVV, price amount, tax amount, etc. and a mechanism for structuring and transmitting the data from the merchant to the card issuer. The messages support payment operations, such as authorizations and refunds, as well as reversals and voids.

Payment processing requires coordination across a large number of companies, each responsible for a specific task. In order to coordinate these transactions, an ISO standard (“ISO 8583”) has been created that dictates the information to be passed between each of the cooperating companies and elements of the payment transaction. This ISO 8583 standard has proved durable, but is limited in the ability to address specialized payment transaction such as those in the managed and constrained payment programs.

Conventional payment processing flows use ISO 8583 messages without knowledge of intermediate elements. Because the intermediate elements are not required to recognize or transmit detailed cart information, transmittal of the detailed cart information between the intermediate elements of the conventional ISO 8583 environment does not occur. Although the ISO 8583 standard allows intermediate elements to mix and match information, without considering the detailed cart information, the ISO 8583 standard only requires the lowest common denominator payload format. This conventional payment processing flows using ISO 8583 lack any detailed cart information.

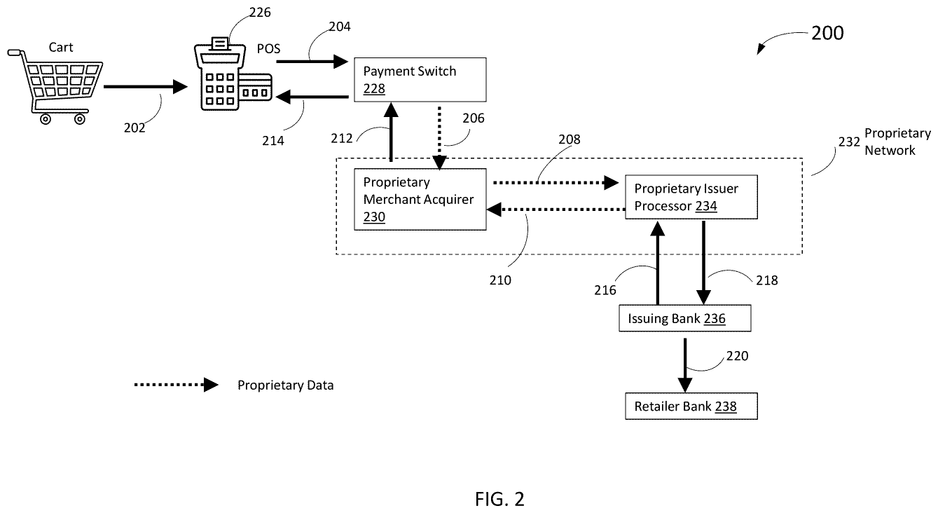

To address the inability to transmit item level cart information over standard ISO 8583, existing art managed and constrained payment processing uses proprietary messages, also known as a closed loop design and disclosed in FIG. 2. These implementations use a series of rules or mandates to interpret a proprietary message involved in transmitting information from the Merchant Acquirer to an Issuer Processor. The proprietary message is also referred to as the transmitted information or detailed cart information. To ensure that the transmitted information flows undisturbed and intact from the point-of-sale (“POS”) through each intermediate element, each intermediate element must recognize the transmitted information in a consistent manner such that there is agreement between each intermediate element. Without this requirement, the intermediate element could revert to the ISO 8583 standard and therefore not transfer unrecognized data. To ensure compliance with this additional requirement, the transmitted information must generally be controlled by single-vendor implementation (a closed loop solution). In this constrained implementation, each intermediate element has knowledge of the transmitted information to ensure that the detailed cart information is not lost. The transmitted information transverses along payment rails between each of the intermediary elements. In the existing art payment processing using proprietary message of FIG. 2, the payment rails are required to transmit large amounts of detailed cart information from each of the intermediary elements. The coordination to update the interfaces of the elements, accept the detailed cart information, and pass down the detailed cart information can be overwhelming and complicated. Thus, the closed loop solution of FIG. 2 constrains the Merchant Acquirer to use the transmitted information with a single vendor.

FIG. 2 illustrates an example flow diagram 200 for existing art managed and constrained payment processing flow using proprietary message through the specific Merchant Acquirer and Issuer Processor. Processing a managed and constrained payment in the existing art requires a proprietary Merchant Acquirer 230 and proprietary Issuer Processor 234 to execute a transaction at a POS 226. These elements cooperate to exchange proprietary messages via the proprietary/closed loop network. The network can be characterized as proprietary because the file format of the data messages is required to be in a particular format that is consistent with the requirements of the respective network components.

At step 202, a transaction is initiated at a POS 226 for scanning and tender. The product or service purchased may be an item or service purchased at the point-of-sale using a payment instrument (e.g., purchase card, tokens, cash, QR code, or other payment instruments). At step 204, the transaction comprises cart content, wherein the content is formatted and presented to merchant's payment switch 228.

At step 206, the payment switch 228 can forward the cart load and tender transaction to a proprietary Merchant Acquirer 230. At step 208, through a proprietary network 232, the Merchant Acquirer 230 can prepare and forward in a proprietary format the transmitted information consistent with the requirements of the proprietary network. This message traverses the proprietary network 232, wherein the transaction is submitted to the proprietary Issuer Processor 234. At step 210, Issuer Processor 234 processes the cart payload against the business rules and returns a tender authorization to the Merchant Acquirer 230 via the proprietary network 232.

Embodiments of the present disclosure remove these proprietary rules or mandates, allowing the detailed item information (e.g., cart information, service code, etc.), category level information, or sub-category level information to be separated from information that is standardized across payment rails. By doing so, the payment transaction regains the ability to use any Merchant Acquirer, payment rail, and Issuer Processor, avoiding the prior constraints of existing methods. Embodiments of the present disclosure use a secondary communication channel to pass the information, separate from ISO 8583 operations. The secondary communication channel may transmit the detailed item information, category level information, or sub-category level information and cardholder information to a receiving system. The receiving system uses that information and information about the cardholder and associated plan characteristics to determine eligibility and availability of funds. Embodiments of the present disclosure allow integration at any point in a payment processing ecosystem that has accurate basket information. The hybrid/secondary channel of embodiments of the present disclosure may integrate any point along the way so long as the system has item information (e.g., item information may be stripped out and added to a secondary communication channel), so as not to constrain the merchant or the issuer. In some embodiments, if there is no information on the hybrid channel, the system may still make decisions based on information that is received natively in the open-loop channel (e.g., because the merchant data, such as the merchant identification or MCC, are known). That is, embodiments of the present disclosure may perform decisions even without a hybrid channel or item level adjudication, based on merchant information.

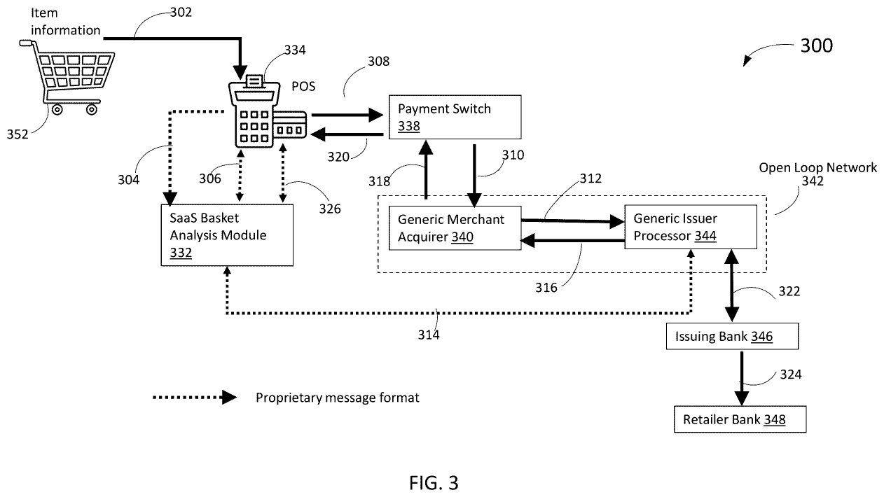

In contrast to the existing art process in FIG. 2, FIG. 3 illustrates an example flow following implementation of the disclosed process. For explanatory purposes, the steps of the example process 300 are described herein as occurring in serial or linearly. However, multiple instances of the example process 300 may occur in parallel. At step 302, item contents (e.g., cart contents, service contents, etc.) are presented for scanning and tender; this action may occur through a client (e.g., through a browser, a mobile device, and/or a point-of-sale (“POS”) device 334). The shopping item information may contain goods and services selected for acquisition by a client. At step 304, the shopping item information contents can be formatted and presented to the BAS Module. In some embodiments, the shopping item information data may be structured in any format (e.g., JSON, YAML, etc.) or any other representation payload transmitted over the secondary channel. At step 306, BAS Module 332 can adjudicate item information content based on item information, cardholder information, program rules, and other business rules. The BAS Module 332 may pre-processes payment information through a ledger. The pre-process may include determining product or service eligibility within a specific program using the Basket Analysis Service to compare basket products or services using specific program rules. The program rules can include, but are not limited to, a particular health program or other set of program rules. The BAS Module 332 may define an application program interface (“API”) structure that allows the POS to present any combination of the category information data, sub-category information data, or item information data for adjudication following a tender action at the POS of the shopping event payload. The API structure can facilitate communication between the POS and BAS. The API describes the shopping event in two or more data sections including: 1) transaction information and 2) item information content information. Transaction information comprises data elements that define the specific merchant and POS device initiating the transaction, such as merchant identifier (“MID”), terminal identifier (“TID”), as well as timestamps and transaction IDs to identify the specific transaction, and an identification of the cardholder. The item information content section includes a record for each specific line item, category level, or sub-category level being purchased within the transaction. Detailed information typically includes an item description consisting of a product or service code, unit price, unit of measure, tax and fee elements, weight, and product or service description.

In a further aspect, the BAS Module can comprise a product or service eligibility engine. The product or service eligibility engine can adjudicate transaction data by managing and applying rules for financial constraints, line-item level, category level, or sub-category level eligibility and velocity constraint. Eligibility may depend on the item, the plan, and member information such as previous purchase history, medical conditions, or other attributes. The product or service eligibility engine may further include a plan and retailer constraint to determine accessibility for a particular retailer and/or a plan constraint such as health care plan. The BAS Module 332 can analyze and record qualified purchase activities. The BAS Module 332 can also store data to generate a system of record for compliance, audit, statements, analytic study, and similar uses.

The BAS Module 332 may further engage in collaborative authorization to manage tender authorizations and transactional integrity. The collaborative authorization is an interaction, separate from the ISO 8583 standard, between an Issuer Processor and a secondary ledger entity. The BAS Module 332 can execute account ledgers for maintaining balances for each type of account (e.g., Member, Funding (“FBO”), Digital discounts, rewards and spending certificates), for accounts generated under the rules of the spend program.

The collaborative authorization may comprise processing the authorization request and returning a tender authorization. Some implementations authorization may include receiving transaction data, which includes a transaction identifier and information about the product or service purchased. The transaction data may be analyzed by aggregating data from multiple transactions and identifying program rules associated with the purchased product or service. The transaction identifier is directly related to the transaction detail as one of the primary identifiers for the superset of data. The program rules may be used to determine product or service eligibility for payment. For example, the program rule could limit a member to $50 per month for over-the-counter medication from a select group of merchants, or restrict a member from purchasing items from a liquor store (even if they would otherwise be permitted), or roll over a member's funds to the first 15 days of the month, etc. Once the product or service eligibility is determined, a transaction message may be generated that indicates the product or service was purchased. The transaction data may be audited by matching the product or service with pricing data associated with the product or service.

At step 308, a POS 334 may tender authorization request to payment switch 338 based upon BAS Module analysis. At step 310, the payment switch 338 can forward tender transaction to a generic Merchant Acquirer 340 in an open-loop network 342. Unlike the restrictions in a proprietary Merchant Acquirer 230 in a proprietary network 232, generic Merchant Acquirer 340 does not require a particular file format to execute a function of the managed and constrained payment process. At step 312, the Merchant Acquirer 340 can prepare and forward a standard ISO 8583 authorization request, and the standard authorization request can be routed through the open-loop network 342. At step 314, the Issuer Processor 344 authorizes the payment transaction. The Issuer Processor 344 may perform a collaborative authorization with the BAS Module 332. Further, the generic Issuer Processor 344 can process the authorization request and returns a tender authorization. Steps 312-314 are examples of existing payment integrations that may be leveraged. The collaboration process between the generic Issuer Processor 344 and the BAS Module 332 is different from the proprietary data structures in FIG. 2 because the message does not depend on proprietary intermediaries and therefore does not constrain the payment processing over an open-loop network.

The preprocessing of the BAS Module 332 examines the entire content of the item information and marks each item as eligible or ineligible, as well as determines how much will be paid for each eligible item. A product or service must be identified within an applicable Approved Product List (“APL”) (e.g., including services) to be eligible. The term Approved Product List is used generically and does not imply a limitation against services or other purchased items. APL data may contain such information as Universal Product Codes (“UPC”), Retailer-Specific Product Codes, Product Lookup (“PLU”) codes, service product codes, and Current Procedural Terminology (“CPT”) codes, among others. To determine eligibility, each item is analyzed against an APL specific to an associated Plan. If a match is found and subsequent rules do not override eligibility, the item is considered eligible. During any payment request from the POS (including payment authorization or payment decline), the BAS can: 1) authorize full payment for all items in the cart; 2) decline payment for all items in the cart; or 3) any hybrid wherein some of the items authorized for payment in whole or part, and others are declined from payment/funding due to balance limits or having non-eligible items in the basket. In cases where items are declined, the POS is required to handle “split tender” transactions.

At step 316, the tender authorization generated by the generic Issuer Processor 344 is routed to the generic merchant acquirer 340 via the open loop network 342. In some embodiments, the open-loop network may require a return ISO message after the Issuer Processor processes the ISO 8583 proper header information. At step 318, the tender authorization is routed to payment switch 338 from the merchant acquirer. At step 320, the payment switch 338 can notify the POS 334 of the tender authorization. Steps 322 and 324 represent standard money movement between the generic Issuer Processor 344, the issuing bank 346, and the Retailer. These steps are included for the sole purpose of emphasizing that embodiments of the present disclosure allow money movement through existing mechanisms and are not intended to be exhaustive or authoritative in their description of how that money movement occurs.

At step 326, POS 334 may inform the BAS Module 332 that the transaction was approved. This step provides additional information from the payment transaction for audit purposes.

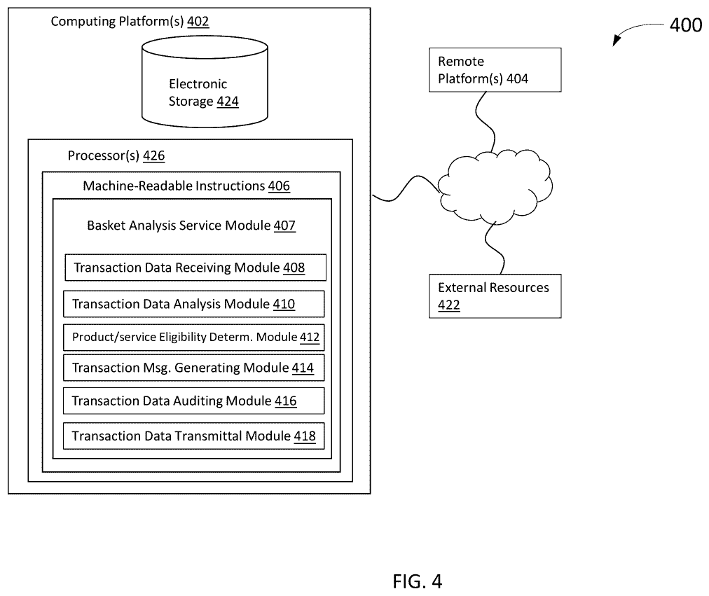

FIG. 4 illustrates a system 400 configured for processing platforms according to certain aspects of the disclosure. In some implementations, system 400 may include one or more computing platforms 402. Computing platform(s) 402 may be configured to communicate with one or more remote platforms 404 according to an API, a client/server architecture, a peer-to-peer architecture, and/or other architectures. Similarly, remote platform(s) 404 may be configured to communicate with other remote platforms via computing platform(s) 402 and/or according to an API, a client/server architecture, a peer-to-peer architecture, and/or other architectures. Users may access system 400 via remote platform(s) 404.

Computing platform(s) 402 may be configured by machine-readable instructions 406. Machine-readable instructions 406 may include one or more instruction modules. The instruction module can comprise a BAS Module 407 that may include computer program modules. The BAS Module 407 may be a controller or coordinator of the overall business process that evaluates the items in a cart, determines eligibility and balances, etc. The balance determination may be based on a single combined balance or may include a plurality of balances each with a designated purpose. These designated purpose balances are referred to as “purses” and an implementation which supports them is known as a “multi-purse” implementation. The BAS Module 407 may include one or more of transaction data receiving module 408, transaction data analysis module 410, product or service eligibility determination module 412, transaction message generating module 414, transaction data auditing module 416, transaction transmittal module 418, and/or other modules.

Transaction data receiving module 408 may be configured to receive transaction data wherein the transaction data is associated with the product or service purchased. The transaction data may be generated based on a purchase with a payment instrument (e.g., purchase card, tokens, cash, QR code, or other payment instruments). The product may be an item purchased at a point-of-sale, a service purchased at the point-of-sale, or other good, product, service, or claim that can be accommodated by the program rules. The transaction data may include information about a purse type associated with the product or service purchased. In some embodiments, system 400 (e.g., product or service eligibility determination module 412) may use the transaction data to classify purchased products or services against one or more funding categories, each of which may have a separate balance. These categories allow for flexible configuration of a payments instrument to associate purchases with specific funding categories, such as healthcare benefits, disaster relief funds, college expenses, or any other category as may be specified by the provider of the funds. The transaction data may include a location where the purchase was made. The transaction data may include a date and time of purchase. The transaction data may include a product or service code associated with the product or service purchased. The product or service code may be associated with a specific medical condition. The transaction data may include an amount of funds available in a payment purse associated with the product or service purchased. The transaction data may include a type of purchase made, such as a co-pay or deductible. The transaction data may include a type of merchant where the purchase was made, such as a general retailer, doctor's office, or hospital. The transaction data may include a cardholder's name and address. The transaction data may be stored in a secure database. The transaction data may include a reason for the purchase, such as a medical condition or prescription. The purchase may include a transaction identifier. The transaction data receiving module 408 may accept raw data elements and validate and decode that message into an internally usable format (e.g., JSON, YAML, etc.). In some implementations, the remote system may combine, filter, or otherwise preprocess the products or services in order to simplify or obscure specific information associated with the products and services.

Transaction data analysis module 410 may be configured to analyze the transaction data. The transaction data analysis module 410 may perform the analysis of the module to determine which items are being present, the dollar amounts, the member, the associated plan, etc. Analyzing the transaction data may include aggregating transaction data from a plurality of transactions. Analyzing the transaction data may include identifying program rules or business rules associated with the product or service purchased. In some implementations, the purchase may be completed at a point of sale. In some implementations, a payment device used to complete the transaction may be identified. In some implementations, the payment device may be a mobile device. In some implementations, the merchant associated with the transaction may be identified.

Product or service eligibility determination module 412 may be configured to determine product or service eligibility for payment based on the program rules associated with the product or service purchased. The product or service eligibility determination module 412 may map the products or services to purse categories based on the eligibility rules and approved product or service lists and eliminate items which are not permitted. The eligibility of the product or service for payment may be verified. Analyzing the transaction data may include determining the product or service eligibility. Determining product or service eligibility for payment based on the program rules associated with the product or service purchased may further include verifying a cardholder's eligibility for a benefit. The program rules associated with the product or service purchased may be updated in real time based on changes in a sponsor's benefit plan. The program rules associated with the product or service purchased may be adjusted based on a cardholder's spending habits. In a further aspect, the product or service eligibility module can also determine a purse associated with each of the program rules. The purse can comprise a monetary allotment for a category of goods under the program rules. For example, in a health care spend program there can be a purse for prescriptions, a purse for co-pays, and a purse for home medical devices (e.g., crutches, inhalers, and the like). Each of the purses can be managed by the BAS by a ledger generated for each purse. As transactions are authorized or denied, the BAS can update the monetary allotment and/or other incentives that can be associated with that respective purse in accordance with the program rules.

Transaction message generating module 414 may be configured to generate a transaction message indicating that the product or service was purchased. A cardholder may be notified of the transaction message. The transaction message may include a response code indicating whether the payment was approved or declined. The transaction message may include a merchant identifier. The transaction message may include an amount of funds available in the payment purse associated with the product or service purchased. The transaction message may include a transaction identifier. The transaction message generating module 414 may take the resulting message and format it into a format suitable for transmission (e.g., JSON, YAML, etc.).

Transaction data auditing module 416 may be configured to record or audit the transaction data associated with the transaction identifier. Auditing the transaction data may include matching the product or service with pricing data associated with the product or service. In some implementations, a log entry for the transaction may be created. The transaction data auditing module 416 may receive and store transaction data for transaction reporting. This allows regulatory bodies, such as CMS, plan sponsors, and other permitted entities to view the transaction details.

Transaction data transmittal module 418 may be configured to transmit all transaction to a third party. After the transaction data receiving module 408 receives the transaction data, the transaction data transmittal module 418 may send a response back to the POS. In some implementations, a detailed breakdown of the purchase may be provided to a cardholder. Rewards may be provided to a cardholder based on the transaction data. A receipt for a cardholder may be generated after the payment is approved.

In some implementations, computing platform(s) 402, remote platform(s) 404, and/or external resources 422 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 402, remote platform(s) 404, and/or external resources 422 may be operatively linked via some other communication media.

A given remote platform 404 may include one or more processors configured to execute computer program modules. The computer program modules may be configured to enable an expert or user associated with the given remote platform 404 to interface with system 400 and/or external resources 422, and/or provide other functionality attributed herein to remote platform(s) 404. By way of non-limiting example, a given remote platform 404 and/or a given computing platform 402 may include one or more of a server, a desktop computer, a laptop computer, a handheld computer, a tablet computing platform, a smartphone, and/or other computing platforms.

External resources 422 may include sources of information outside of system 400, external entities participating with system 400, and/or other resources. In some embodiments, resources may include previous plan sponsor systems that describe the allowed elements, purse configurations, or periodic amounts; industry databases for items, such as Universal Product Codes (“UPCs”); or merchant databases for items, such as private label items or retailer-specific product codes. In some implementations, some or all of the functionality attributed herein to external resources 422 may be provided by resources included in system 400.

Computing platform(s) 402 may include electronic storage 424, one or more processors 426, and/or other components. Computing platform(s) 402 may include communication lines, or ports to enable the exchange of information with a network and/or other computing platforms. Illustration of computing platform(s) 402 in FIG. 4 is not intended to be limiting. Computing platform(s) 402 may include a plurality of hardware, software, and/or firmware components operating together to provide the functionality attributed herein to computing platform(s) 402. For example, computing platform(s) 402 may be implemented by a cloud of computing platforms operating together as computing platform(s) 402.

Electronic storage 424 may comprise non-transitory storage media that electronically stores information. The electronic storage media of electronic storage 424 may include one or both of system storage that is provided integrally (i.e., substantially non-removable) with computing platform(s) 402 and/or removable storage that is removably connectable to computing platform(s) 402 via, for example, a port (e.g., a USB port, a firewire port, etc.) or a drive (e.g., a disk drive, etc.). Electronic storage 424 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 424 may include one or more virtual storage resources (e.g., cloud storage, a virtual private network, and/or other virtual storage resources). Electronic storage 424 may store software algorithms, information determined by processor(s) 426, information received from computing platform(s) 402, information received from remote platform(s) 404, and/or other information that enables computing platform(s) 402 to function as described herein.

Processor(s) 426 may be configured to provide information processing capabilities in computing platform(s) 402. As such, processor(s) 426 may include one or more of a digital processor, an analog processor, a digital circuit designed to process information, an analog circuit designed to process information, a state machine, and/or other mechanisms for electronically processing information. Although processor(s) 426 is shown in FIG. 4 as a single entity, this is for illustrative purposes only. In some implementations, processor(s) 426 may include a plurality of processing units. These processing units may be physically located within the same device, or processor(s) 426 may represent processing functionality of a plurality of devices operating in coordination. Processor(s) 426 may be configured to execute modules 408, 410, 412, 414, 416, and/or 418, and/or other modules. Processor(s) 426 may be configured to execute modules 408, 410, 412, 414, 416, and/or 418, and/or other modules by software; hardware; firmware; some combination of software, hardware, and/or firmware; and/or other mechanisms for configuring processing capabilities on processor(s) 426. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 408, 410, 412, 414, 416, and/or 418 are illustrated in FIG. 4 as being implemented within a single processing unit, in implementations in which processor(s) 426 includes multiple processing units, one or more of modules 408, 410, 412, 414, 416, and/or 418 may be implemented remotely from the other modules. The description of the functionality provided by the different modules 408, 410, 412, 414, 416, and/or 418 described below is for illustrative purposes, and is not intended to be limiting, as any of modules 408, 410, 412, 414, 416, and/or 418 may provide more or less functionality than is described. For example, one or more of modules 408, 410, 412, 414, 416, and/or 418 may be eliminated, and some or all of their functionality may be provided by other ones of modules 408, 410, 412, 414, 416, and/or 418. As another example, processor(s) 426 may be configured to execute one or more additional modules that may perform some or all of the functionality attributed below to one of modules 408, 410, 412, 414, 416, and/or 418.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

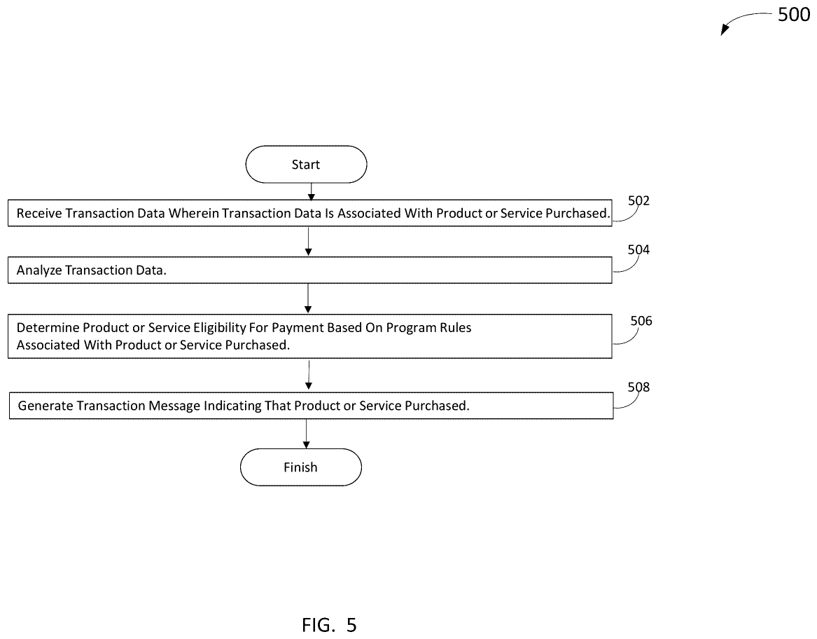

FIG. 5 illustrates an example flow diagram (e.g., process 500) for processing platforms according to certain aspects of the disclosure. For explanatory purposes, the example process 500 is described herein with reference to FIGS. 1-4. Further, for explanatory purposes, the steps of the example process five hundred are described herein as occurring in serial or linearly. However, multiple instances of the example process 500 may occur in parallel. FIG. 5 represents the communication on the hybrid channel and does not include flows specific to standard (“ISO 8583”) payment processing.

At step 502, the process 500 may include receiving transaction data wherein the transaction data is associated with the product or service purchased. The purchase may include a transaction identifier. In some embodiments the information may be limited to merchant identifiers such as MID or MCC. Step 502 also includes receiving and decoding the information from the merchant. The modules may be the BAS Module 407 and the transaction data receiving module 408. At this stage, in some embodiments, no program rules may be involved. Step 502 may decode and prepare the data for future processing.

At step 504, the process 500 may include analyzing the transaction data. Analyzing the transaction data may include aggregating transaction data from a plurality of transactions, identifying program rules associated with the product or service purchased associated with each of the plurality of transactions. Step 504 may use the BAS Module 407 and transaction data analysis module 410 to decode data from the previous stage, determine the member and plan, and load the plan rules.

At step 506, the process 500 may include determining product or service eligibility for payment based on the program rules associated with the product or service purchased. Step 506 may use the BAS Module 407 and product or service eligibility determination module 412 to determine the appropriate purse(s) for each item and make eligibility decisions. The eligibility decisions may be determined by program rules, such as payment plan, merchant, corporate program, or other criteria. This includes the adjudication, preparation for the adjudication, and the interpretation of the adjudication. The preparation for adjudication may include determining which items are eligible for purchase based on the program rules. When the transaction occurs, a normalization step takes the transaction data and checks that the transaction data is in usable format.

At step 508, the process 500 may include generating a transaction message indicating that the product or service was purchased. The message may include a transaction identifier. Step 508 may use the BAS Module 407, transaction data auditing module 416, and transaction data transmittal module 418 to prepare the results for transmission back to the merchant and the transaction data auditing module 416. By sending the results to the transaction data auditing module, the data may be logged and audited.

For example, as described above in relation to FIG. 4, at step 502, the process 500 may include receiving transaction data wherein the transaction data is associated with the product or service purchased through transaction data receiving module 408. The purchase may include a transaction identifier. At step 504, the process 500 may include analyzing the transaction data through transaction data analysis module 410. Analyzing the transaction data may include aggregating transaction data from a plurality of transactions, identifying program rules associated with the product or service purchased associated with each of the plurality of transactions. At step 506, the process 500 may include determining product or service eligibility for payment based on the program rules associated with the product or service purchased through product or service eligibility determination module 412. At step 508, the process 500 may include generating a transaction message indicating that the product or service was purchased through transaction message generating module 414. The message may include a transaction identifier.

According to an aspect, the transaction data is generated (e.g., by POS device 334 of FIG. 3) based on a purchase with a payment instrument (e.g., a purchase card, tokens, cash, QR code, or other payment instruments), wherein the purchase is completed at a point of sale.

According to an aspect, the process 500 may include auditing of the transaction data associated with the transaction identifier.

According to an aspect, auditing the transaction data may comprise matching the product or service with pricing data associated with the product or service.

According to an aspect, the process 500 may include applying digital discounts to transaction data.

According to an aspect, the process 500 may include transmitting all transactions to a third party.

According to an aspect, the product or service is an item purchased at a point-of-sale or a service purchased at the point-of-sale, or similar goods, produce, or service purchased.

According to an aspect, the transaction data may further comprise information about a purse type associated with the product or service purchased.

According to an aspect, the purse type may be associated with a healthcare benefit or other program that requires managed and controlled spending.

According to an aspect, the transaction data may further comprise a location where the purchase was made

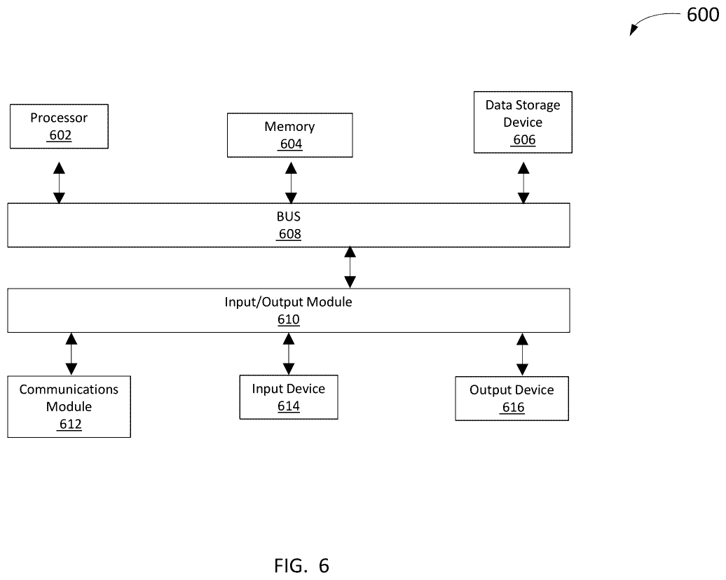

FIG. 6 is a block diagram illustrating an exemplary computer system 600 with which aspects of the subject technology can be implemented. In certain aspects, the computer system 600 may be implemented using hardware or a combination of software and hardware, either in a dedicated server, integrated into another entity, or distributed across multiple entities. The elements described may be implemented on a standard or custom-built computer or specialized hardware.

Computer system 600 (e.g., server and/or client) includes a bus 608 or other communication mechanism for communicating information, and a processor 602 coupled with bus 608 for processing information. By way of example, the computer system 600 may be implemented with one or more processors 602. Processor 602 may be a general-purpose microprocessor, a microcontroller, a Digital Signal Processor (“DSP”), an Application Specific Integrated Circuit (“ASIC”), a Field Programmable Gate Array (“FPGA”), a Programmable Logic Device (“PLD”), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604, such as a Random Access Memory (“RAM”), a flash memory, a Read-Only Memory (“ROM”), a Programmable Read-Only Memory (“PROM”), an Erasable PROM (“EPROM”), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, i.e., one or more modules of computer program instructions encoded on a computer-readable medium for execution by, or to control the operation of, the computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and XML-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606, such as a magnetic disk or optical disk, coupled to bus 608 for storing information and instructions. Computer system 600 may be coupled via input/output module 610 to various devices. The input/output module 610 can be any input/output module. Exemplary input/output modules 610 include data ports such as USB ports. The input/output module 610 is configured to connect to a communications module 612. Exemplary communications modules 612 include networking interface cards, such as Ethernet cards and modems. In certain aspects, the input/output module 610 is configured to connect to a plurality of devices, such as an input device 614 and/or an output device 616. Exemplary input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 616 include display devices such as an LCD (liquid crystal display) monitor, printers, for displaying information to the user.

According to one aspect of the present disclosure, the above-described systems can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in the main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, Wi-Fi, Bluetooth, NFC, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires that comprise bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the computer system 600 reads data, the data from the memory 604 servers accessed via a network the bus 608, or the data storage 606 may be read and loaded into the memory 604. Although data is described as being found in the memory 604, it will be understood that data does not have to be stored in the memory 604 and may be stored in other memory accessible to the processor 602 or distributed among several media, such as the data storage 606.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for processing transaction data, the method comprising:
receiving transaction data,
wherein
the transaction data is associated with a product or service purchased,
the purchase comprises a transaction identifier, and
the transaction data comprises information regarding products or services desired to be purchased and information to identify an open-loop transaction in a mutually agreed upon format, prior to initiation of the open-loop transaction;
analyzing the transaction data, wherein analyzing the transaction data includes:
aggregating transaction data from a plurality of transactions,
identifying program rules associated with the product or service purchased associated with each of the plurality of transactions, and
determining product or service eligibility for payment based on the program rules associated with the product or service purchased; and
generating a transaction message indicating that the product or service was purchased, wherein the transaction message comprises a transaction identifier.

2. The method of claim 1, wherein the transaction data is generated based on a purchase with a payment instrument, wherein the purchase is completed at a point of sale or channel capable of completing purchase of the product or service.

3. The method of claim 1, further comprising auditing of the transaction data associated with the transaction identifier.

4. The method of claim 3, wherein auditing the transaction data comprises matching the product or service with pricing data associated with the product or service.

5. The method of claim 1, further comprising at least one purse, wherein the purse comprises an account associated with the program rules associated with the product or service purchased.

6. The method of claim 5, further comprising determining a ledger associated with the at least one purse, wherein the ledger is adjusted in response to a determination of product or service eligibility.

7. The method of claim 1, wherein the product or service is an item purchased at a point-of-sale or a service purchased at the point-of-sale.

8. The method of claim 1, wherein the transaction data further comprises information about a purse type associated with the product or service purchased.

9. The method of claim 8, wherein the purse type is associated with a sponsored benefits program or another program requiring managed and controlled spending.

10. The method of claim 1, further comprising causing an issuing bank to transfer payment to a retailer bank.

11. A system configured for processing transaction data, the system comprising:
one or more hardware processors configured by machine-readable instructions to:
receive transaction data, wherein the transaction data is associated with a product or service purchased,
wherein
the transaction data is generated based on a purchase with a payment instrument,
the purchase is completed at a point of sale, wherein the purchase comprises a transaction identifier, and
the transaction data comprises information regarding products or services desired to be purchased and information to identify an open-loop transaction, prior to initiation of the open-loop transaction;
analyze the transaction data, wherein analyzing the transaction data includes:
aggregating transaction data from a plurality of transactions,
identifying program rules associated with the product or service purchased associated with each of the plurality of transactions, and
determining product or service eligibility for payment based on the program rules associated with the product or service purchased; and
generate a transaction message indicating that the product or service was purchased, wherein the transaction message comprises a transaction identifier.

12. The system of claim 11, wherein a payment device used to complete the transaction is identified.

13. The system of claim 12, wherein the payment device is a mobile device.

14. The system of claim 11, wherein rewards are provided to a cardholder based on the transaction data.

15. The system of claim 11, wherein a merchant associated with the transaction is identified.

16. The system of claim 11, wherein the eligibility of the product or service for payment is verified.

17. The system of claim 11, wherein determining product or service eligibility for payment based on the program rules associated with the product or service purchased further comprises verifying a cardholder's eligibility for a benefit.

18. The system of claim 11, wherein the transaction data further comprises a product or service code associated with the product or service purchased.

19. The system of claim 11, wherein the program rules associated with the product or service purchased are updated in real time based on changes in a purse sponsor's benefit plan.

20. A non-transient computer-readable storage medium having instructions embodied thereon, the instructions being executable by one or more processors to perform a method for processing transaction data, the method comprising:
receiving transaction data wherein the transaction data is associated with a product or service purchased,
wherein
the transaction data is generated based on a purchase with a payment instrument,
the purchase is completed at a point of sale, wherein the purchase comprises a transaction identifier, and
the transaction data comprises information regarding products or services desired to be purchased and information to identify an open-loop transaction, prior to initiation of the open-loop transaction;
auditing of the transaction data associated with the transaction identifier, wherein auditing the transaction data comprises matching the product or service with pricing data associated with the product or service;
analyzing the transaction data, wherein analyzing the transaction data includes:
aggregating transaction data from a plurality of transactions,
identifying program rules associated with the product or service purchased associated with each of the plurality of transactions, and
determining product or service eligibility for payment based on the program rules associated with the product or service purchased; and
generating a transaction message indicating that the product or service was purchased, wherein the transaction message comprises a transaction identifier.

21. The method of claim 1, wherein the transaction data is received on a first channel and standard payment processing data is received on a second channel.

22. The method of claim 21, wherein the first channel is a hybrid channel.
